(19) United States
(12) Patent Application Publication
(10) Pub. No.: US 2025/0219935 A1
(43) Pub. Date: Jul. 3, 2025

(54) METHOD AND APPARATUS OF TRAFFIC ROUTING CONTROL

(71) Applicant: Lenovo (Beijing) Limited, Beijing (CN)

(72) Inventors: Tingfang Tang, Beijing (CN); Haiyan Luo, Shanghai (CN)

(73) Assignee: Lenovo (Beijing) Limited, Beijing (CN)

(21) Appl. No.: 18/852,402

(22) PCT Filed: Mar. 29, 2022
(86) PCT No.: PCT/CN2022/083769

§ 371 Date: Sep. 27, 2024

(51) Int. Cl. H04L 45/302; H04W 40/02

(52) U.S. Cl. CPC H04L 45/306; H04W 40/02

(57) ABSTRACT

Embodiments of the present application relate to a method and apparatus of traffic routing control. An exemplary method includes: receive or retrieve service specific information of a user equipment (UE) requesting to access an application; match the service specific information of the UE with service information for a set of UEs, wherein the service information is associated with traffic routing information targeting the set of UEs; and transmit a traffic routing policy based on the service information and the traffic routing information to influence a receiving NF of session management for routing decisions for traffic.

### TECHNICAL FIELD

Embodiments of the present application are related to wireless communication technology, and more particularly, related to a method and apparatus of traffic routing control.

### BACKGROUND

Wireless communication technologies have been developed to support edge computing within 5G architecture. In edge computing deployment, one application service may be served by multiple edge application servers (EAS) typically deployed in different sites. These multiple EAS instances that host the same content or service may use a single Internet protocol (IP) address (anycast address) or different IP addresses. User equipment (UE) accesses an application server (AS) via a user plane (UP) function (UPF), which is used as a protocol data unit (PDU) session anchor (PSA). PDU sessions are established between the UE and the PSA UPF. One PDU session may support one or more applications. Before an application or UE starts to connect to the service, it is very important for the application or UE to discover an IP address of a suitable EAS (e.g., the one closest to the UE), so that the traffic can be locally routed to the EAS via uplink classifier (UL CL) or branching point (BP) mechanisms or a PDU session established directly with the local data network (DN) where the EAS is deployed, and service latency, traffic routing path and user service experience can be optimized.

To provide the traffic offload policy, an application function (AF) influence on traffic routing mechanism is defined within 5G architecture. An AF may send requests to influence session management function (SMF) routing decisions for traffic of PDU sessions. The AF requests may also influence UPF (re) selection and allow routing user traffic to a local access to a DN, which can be identified by a data network access identifier (DNAI). Traffic offload policy can be provided per group, wherein AF requests can target a group of UE and each group member is identified by generic public subscription Identifier (GPSI) or subscription permanent identifier (SUPI).

However, the mechanism of providing traffic offload policy per group cannot meet the requirement of providing traffic routing control on a set of UEs in a finer granularity. Thus, improvements on traffic routing controlling is desired.

### SUMMARY

One objective of the present application is to provide a solution of traffic routing control, e.g., a method and apparatus of traffic routing control, especially for improving traffic routing in a network with edge computing deployment.

According to some embodiments of the present application, a network function (NF) of policy control, e.g., PCF is provided, which includes: a transceiver; and a processor coupled to the transceiver, wherein the processor is configured to: receive or retrieve service specific information of a UE requesting to access an application; match the service specific information of the UE with service information for a set of UEs, wherein the service information is associated with traffic routing information targeting the set of UEs; and transmit a traffic routing policy based on the service information and the traffic routing information to influence a receiving NF of session management for routing decisions for traffic.

According to some other embodiments of the present application, a method of routing controlling is provided, which includes: receive or retrieve service specific information of a UE requesting to access an application; match the service specific information of the UE with service information for a set of UEs, wherein the service information is associated with traffic routing information targeting the set of UEs; and transmit a traffic routing policy based on the service information and the traffic routing information to influence a receiving NF of session management for routing decisions for traffic.

In some embodiments of the present application, the service information may include one or more of the following: an application client category associated with a service level of the application; an allowance indication for the application; or an application identifier associated with an application instance. In the case that the service information includes an allowance indication, the service information further includes information specified for the allowance indication according to some embodiments of the present application.

In some embodiments of the present application, the service information for the set of UEs is received in an application function influence on traffic routing procedure. The service information is included as a kind of targeting UE identifiers in an application function request or as separate information which can be combined with the targeting UE identifiers to identify the set of UEs.

In some embodiments of the present application, the service information is configured in mobile network side, and is directly stored in the NF of policy control or stored in a NF of unified data repository.

In some embodiments of the present application, the service specific information of the UE is associated with UE identifier or UE address.

In some embodiments of the present application, the service specific information of the UE is received via a procedure of setting up an application function (AF) session with required quality of service (QOS), or via a procedure of service specific parameter provisioning or the procedure of application function influence on traffic routing.

In some embodiments of the present application, the service specific information of the UE is configured in mobile network side, and is directly stored in the NF of policy control or stored in a NF of unified data repository. For example, the service specific information of the UE is configured to include one or more of the following: allowed edge service information, including an identifier of at least one application which can be accessed using edge computing by the UE; and service information of each application for a set of UEs to which the UE belongs in the allowed edge service information.

In some embodiments of the present application, the processor is configured to: transmit a request to the NF of session management to update the traffic routing policy in response to at least one of the service information for the set of UEs or the service specific information of the UE being updated.

Embodiments of the present application can provide different services to different users for the application, which can identify a set of UEs at a finer granularity, which can be dynamically managed, thus being advantageous in user experience and cost etc.

### BRIEF DESCRIPTION OF THE DRAWINGS

In order to describe the manner in which advantages and features of the present application can be obtained, a description of the present application is rendered by reference to specific embodiments thereof which are illustrated in the appended drawings. These drawings depict only exemplary embodiments of the present application and are not therefore intended to limit the scope of the present application.

FIG. 1 illustrates an exemplary network architecture supporting edge computing, in accordance with some embodiments of the present application.

FIG. 2 illustrates a flow chart of a method of traffic routing control according to some embodiments of the present application.

FIG. 3 illustrates an exemplary procedure of traffic routing controlling based on the service information for PDU session using UL CL according to some embodiments of the present application.

FIG. 4 illustrates a procedure of setting up an AF session with required QoS according to some embodiments of the present application.

FIG. 5 illustrates a procedure of service specific parameter provisioning according to some embodiments of the present application.

FIG. 6 illustrates a procedure of application function influence on traffic routing according to some embodiments of the present application.

FIG. 7 illustrates an exemplary procedure of traffic routing controlling based on the service information for PDU session using multi-homing according to some embodiments of the present application.

FIG. 8 illustrates an exemplary procedure of traffic routing controlling based on the service information for PDU session using SSC mode 2 according to some embodiments of the present application.

FIG. 9 illustrates an exemplary procedure of traffic routing controlling based on application instance according to some embodiments of the present application.

FIG. 10 illustrates an exemplary block diagram of an apparatus of routing control according to some embodiments of the present application.

FIG. 11 illustrates an exemplary block diagram of an apparatus of routing control according to some other embodiments of the present application.

### DETAILED DESCRIPTION

The detailed description of the appended drawings is intended as a description of the currently preferred embodiments of the present application and is not intended to represent the only form in which the present application may be practiced. It is to be understood that the same or equivalent functions may be accomplished by different embodiments that are intended to be encompassed within the spirit and scope of the present application.

In the following description, numerous specific details are provided, such as examples of programming, software modules, network transactions, database structures, hardware modules, hardware circuits, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference will now be made in detail to some embodiments of the present application, examples of which are illustrated in the accompanying drawings. To facilitate understanding, embodiments are provided under specific network architecture and new service scenarios, such as 3rd Generation Partnership Project (3GPP) 5G, 3GPP Long Term Evolution (LTE) and so on. Persons skilled in the art know very well that, with the development of network architecture and new service scenarios, the embodiments in the present application are also applicable to similar technical problems; and moreover, the terminologies recited in the present application may change, which should not affect the principle of the present application.

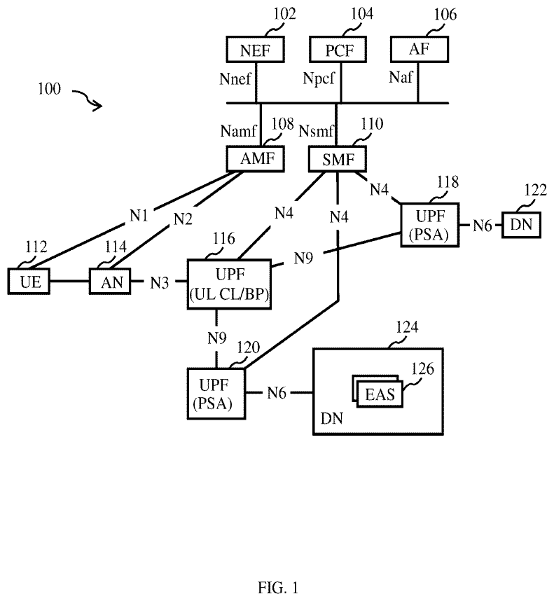

FIG. 1 illustrates an exemplary network architecture 100 supporting traffic offloading. The network architecture 100 includes several network functions (NFs), in which the techniques, processes and methods described herein can be implemented, in accordance with various embodiments. An NF may be implemented either as a network element on a dedicated hardware, as a software instance running on a dedicated hardware, or as a virtualized function instantiated on an appropriate platform, e.g., a cloud infrastructure. A single NF may be implemented by a single entity or multiple entities in conjunction.

Seen from the core network side, the network architecture 100 shown in FIG. 1 includes a network exposure function (NEF) 102, a policy control function (PCF) 104, an AF 106, an access and mobility management function (AMF) 108, and a SMF 110. Nnef is a service-based interface exhibited by the NEF 102. Npcf is a service-based interface exhibited by the PCF 104. Naf is a service-based interface exhibited by the AF 106. Namf is a service-based interface exhibited by the AMF 108. Nsmf is a service-based interface exhibited by the SMF 110.

Seen from the access side, the network architecture 100 shown in FIG. 1 includes a UE 112 connected to an access network (AN) 114 and the AMF 108. The UE 112 communicates with the AMF 108 via an interface N1. The AN 114 includes one or more base stations (BSs) (not shown), e.g., enhanced or evolved Node Bs (eNBs), 5G base stations (gNBs) or the like. The AN 114 may connect to a first data network (DN) 122 via a first user plane function (UPF) 116 and a second UPF 118, and to a second DN 124 via the first UPF 116 and a third UPF 120. The AN 114 communicates with the AMF 108 via an interface N2, and communicates with the first UPF 116 via an interface N3. A UPF to steer a traffic can be a uplink classifier (UL CL) or branching point (BP) UPF, e.g., the first UPF 116 when there are multiple PSA UPFs, e.g., the second UPF 118 and the third UPF 120 for a PDU session. The UL CL or BP UPF can be a standalone UPF or be co-located with a PSA UPF. The UPF to steer a traffic can also be a PSA UPF or a UPF of N3 terminating point when there is only one PSA UPF for a PDU session, that is, there is no UL CL or BP UPF. The SMF 110 may make routing decisions for traffic of PDU sessions. For example, the SMF 110 may decide to select which one of the first UPF 118 and the second UPF 120 as a PSA for traffic. The first UPF 116, second UPF 118 and third UPF 120 communicate with the SMF 110 via an interface N4, respectively. The UPF 116 communicates with the second UPF 118 and third UPF 120 via an interface N9, respectively. The second UPF 118 and third UPF 120 communicate with the first DN 122 and second DN 124 via an interface N6, respectively. Although only one UE and two DNs are depicted in FIG. 1, it is contemplated that any number of UEs and DNs may be included in the network architecture 100. Further, the network architecture 100 may also include other components, for example, other NFs not shown in FIG. 1.

Service (or application or the like) providers may deploy applications into one or more DNs, e.g., an edge DN which is a local part of the DN or local access of the DN, or a central DN. The applications may be served by one or more EASs 126 deployed in a DN, e.g., the second DN 124. Other DNs, e.g., the first DN 122 may also include one or more EAS. Multiple EAS instances that host the same content or service may use a single IP address (anycast address) or different IP addresses. The IP address of a suitable EAS (e.g., the one closest to the UE) will be discovered for the application or UE, so that the traffic can be locally routed to the EAS. The AF 106 can get the traffic routing information (TRI) for the deployed applications. Thus, traffic routing control is very important for optimizing service latency, traffic routing path and user service experience.

To enhance traffic routing control, in the work for FS_EDGE_Ph2 in 3GPP R18, key issue (KI) #3: policies for finer granular sets of UEs and KI #4: influencing UPF and EAS (re) location for collections of UEs are discussed.

According to some embodiments of the present application, to identify a set of UEs at a finer granularity, a pre-defined set of UEs or a dynamic set of UEs can be used. The set of UEs can be decided by the network administrator or by the application (or application service provider). The set of UE can also be referred to a group of UE, a UE group, a collection of UE or the like. For example, the set of UEs can be a per-configured group which is be configured by the mobile network operator (MNO). The set of UEs can also be a dynamic group which can be managed dynamically by the AF, e.g., using the 5G virtual network (VN) group management mechanism defined within a 5G architecture, wherein each 5G VN group member is uniquely identified by a GPSI. However, several technical problems still need to be solved.

For example, one technical problem to be solved is: how to identify the set of UE at a finer granularity that are associated with specific service provided either by operator or application service provider, considering specific criteria decided to provide different services and how to support providing traffic offload policy for such a set of UE.

Embodiments of the present application provide a technical solution of traffic routing control, e.g., a method and apparatus of traffic routing control, which can at least solve the above technical problems.

In some embodiments of the present application, different application clients or users are provided with different services, e.g., only Gold or Level A application clients can access the service using edge computing. Service information is provided for a set of UEs accessing an application or service or the like, which is associated with traffic routing information targeting the set of UEs.

An example of the service information may include an application client category associated with a service level of the application. The service level is based on a specific right or capability of accessing the application, e.g., Gold users with the highest right of accessing the application, and Sliver users with the medium right of accessing the application. Another example of the service information may include an allowance indication for the application, which indicates the set of UE is allowed to access the application. Further information, e.g., performance levels can be specified for the allowance indication in some embodiments of the present application. For example, Level A application clients are allowed to access the service using edge computing with the highest performance, Level B application clients are allowed to access the service using edge computing with medium performance etc. Yet another example of the service information may include an application identifier associated with an application instance (also referred to as an application instance identifier). For example, in an online multiplayer game, players within the same match can share the same traffic routing controlling. An application identifier associated with the match will be used for these players. In some embodiments of the present application, the service information for a set of UEs may include only one kind of service information, e.g., application client category. In some other embodiments of the present application, the service information for a set of UEs may include two or more kinds of service information, e.g., both application client category and application instance identifier etc.

The service information may be provisioned in the application side or can be configured in the mobile network side. When the service information is provisioned in the application side, a NF of application, e.g., the AF 106 shown in FIG. 1 can get the service information and transmit it to a NF of policy control, e.g., the PCF104 shown in FIG. 1, so that UEs with different rights or capabilities to access the application can be differentiated in a fine granularity. When the service information is configured in the mobile network side, it can be directly stored in the NF of policy control, e.g., the PCF or stored in a NF of unified data repository, e.g., a UDR. Similarly, the traffic routing information associated with the service information may also be provisioned in the application side or can be configured in the mobile network side.

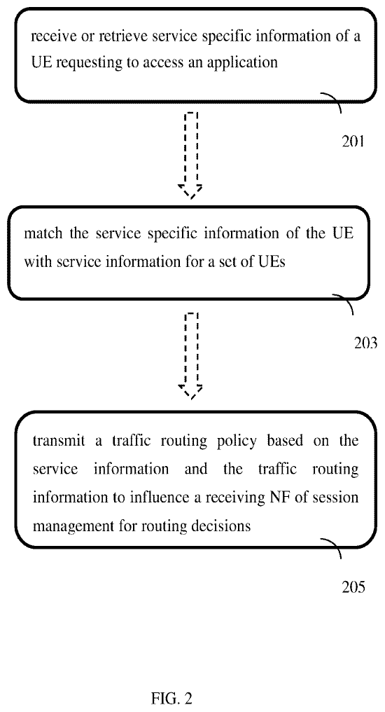

FIG. 2 illustrates a flow chart of a method of traffic routing control according to some embodiments of the present application, which can be performed by a NF of policy control, e.g., a PCF 104 shown in FIG. 1 or the like.

Referring to FIG. 2, for a specific UE requests to access an application, the PCF 104 may receive or retrieve service specific information of the UE in step 201. The service specific information of the UE indicates to which set of UEs identified by the service information the UE belongs. For example, the service specific information of the UE may indicate that the UE is a Level A user of the application.

Thus, the service specific information is defined or configured in the same manner as the service information of the application, so that the UE can be provided the correct right or capability of accessing the application. The service specific information can be associated with an identifier of the UE, e.g., UE ID being GPSI or SUPI or address of the UE, e.g., UE IP address.

Similarly, the service specific information of the UE can also be provided in the application side, and the PCF 104 can receive the service specific information of the UE from the AF 106, e.g., by a procedure of setting up an AF session with required QoS defined in 3GPP TS 23.502 clause 4.15.6.6, or by a procedure of service specific parameter provisioning defined in 3GPP TS 23.502 clause 4.15.6.7, or by a procedure of application function influence on traffic routing as defined in 3GPP TS 23.502 clause 4.3.6.4.

In some other embodiments of the present application, the service specific information can be configured in the mobile network side, which is directly stored in the PCF 104 or stored in the UDR. For example, the service specific information of the UE is configured to include: allowed edge service information, including identifier of at least one application which can be accessed using edge computing by the UE; and service information of each application for a set of UEs to which the UE belongs in the allowed edge service information. Accordingly, the PCF 104 will retrieve the stored service specific information of the UE in response to the request of the UE to access the application.

Persons skilled in the art should well know that “UE” herein may refer to an application user accessing an application via the UE or the UE itself. For example, in the case that the service specific information is received from the AF, the service specific information of the UE also refers to the service specific information of a user of the application (application client) accessing the application via the UE. The ID of the user may be bonded to the UE ID, e.g., SUPI or GPSI etc. Similarly, the address of the user may be bonded to the UE address, e.g., the IP address used by the UE accessing the application. For a UE used in the wireless network, its right or capability of accessing an application may be configured based on its own ID in some scenarios so that any user of the application accessing the application via the UE with the same right or capability.

After receiving or retrieving the service specific information of the UE, the PCF 104 will match the service specific information of the UE with service information for a set of UEs in step 203. Since the service information for a set of UEs is associated traffic routing information targeting the set of UEs, the traffic routing information for the UE will be determined in the case that the service specific information of the UE is matched with the service information. For example, for a Gold user of the application, traffic routing information targeting the set of Gold users will be determined. The service information for a set of UEs associated with traffic routing information can be received from the AF 106, e.g., by a procedure of application function influence on traffic routing as defined in 3GPP TS 23.502 clause 4.3.6.4 or configured in the mobile network side.

The PCF 104 will make a decision to modify session policy for the application within the PDU session for the UE, and generate a traffic routing policy based on the service information and the traffic routing information. In step 205, the PCF 104 will transmit the generated traffic routing policy to influence a receiving NF of session management, e.g., the SMF 110 shown in FIG. 1 for traffic routing decisions.

Technical solution of traffic routing control using the service information can be applied to all kinds of PDU sessions, including PDU session with multiple anchors using UL CL or multi-homing, service and session continuity (SSC) mode 1 PDU session, SSC mode 2 PDU session, and SSC mode 3 session etc. More detailed embodiments of the present application will be illustrated in the following in view of various kinds of PDU sessions. Persons skilled in the art although some procedures illustrated in embodiments of the present application have been defined in current 3GPP specification, they may evolve in the future as 3GPP develops while still be adaptive to the technical solution sought to be protected by the present application. Scope of embodiments of the present application should not be limited to the specific terms of these procedures. In addition, although a certain configuration or provisioning manner of the service information and service specific information is illustrated in a certain procedure and/or a certain kind of PDU session, persons skilled in the art should well know that they can be combined in any manners and should not be limited to the specific embodiments illustrated in the following.

First, taking a PDU session with multiple anchors using UL CL as example, according to some embodiments of the present application, the local PDU session anchor is L-UPF selected based on traffic routing information, the central PSA is C-UPF, and the UE address does not change during the lifetime of the PDU session. The PCF decides to send the policy and charging control (PCC) rule with the traffic routing policy, which is generated and delivered based on service information and traffic routing policy matched or associated with the service information.

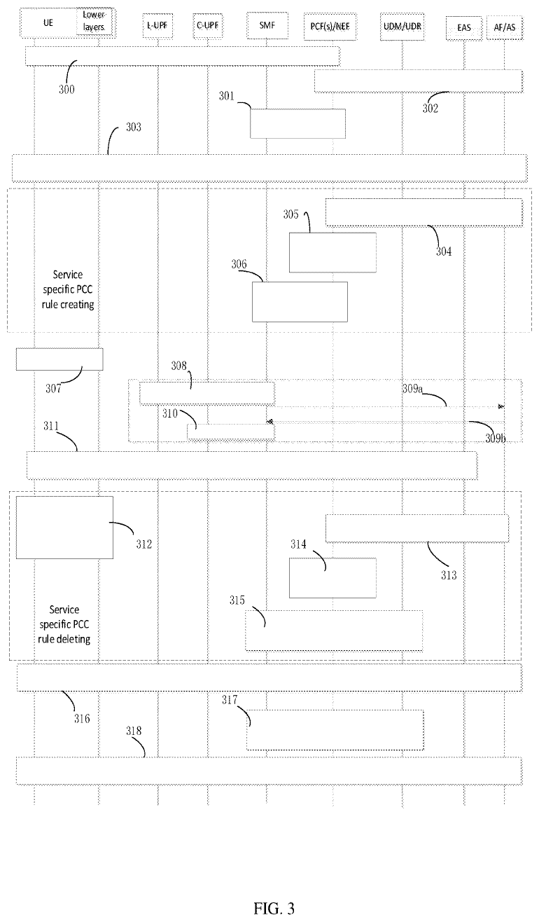

FIG. 3 illustrates an exemplary procedure of traffic routing controlling based on the service information for PDU session using UL CL according to some embodiments of the present application. It is supposed that both the service information for a set of UEs and the service specific information of a specific UE is configured in the application side in the illustrated embodiments shown in FIG. 3.

Referring to FIG. 3, in a scenario of traffic routing controlling for an application accessed via a PDU session using UL CL, a UE initiates the PDU session establishment procedure in step 300 to request accessing the application.

The SMF may retrieve the SM policy using a SM policy association establishment procedure during the PDU session establishment procedure in step 301. The traffic routing policy for the application may also be retrieved in this step. However, since no service information has been matched yet, there is no traffic routing policy for the specific application sent to the SMF for the PDU session.

In step 302, the AF will transmit the service information, e.g., an application client category of the application to the PCF with the ID of the application, e.g., by an AF request in an application function influence on traffic routing procedure defined in 3GPP TS 23.501 and TS 23.502. The traffic routing information associated with the service information for the set of UEs can also be included in the AF request, which may include a DNAI list per application or per traffic. Herein, traffic routing information can be partial or all information in the AF request. The AF request may influence UPF (re) selection and allow routing the traffic to a local access to a DN identified by a DNAI. The service information will acts as the criteria to identify the UE(s) that the AF request is targeting. So, the traffic routing information associated with the service information can only be applied to the PDUs which are allowed to access the application with the service information.

According to 3GPP TS 23.501 clause 5.6.7, an existing AF requests may contain the information as described in following Table 1.

TABLE 1
Information element contained in an AF request

| Information | | Applicable for NEF | |
|---|---|---|---|
| Name | Applicable for PCF or NEF | only | Category |
| Traffic | Defines the target traffic to be | The target traffic can | Mandatory |
| Description | influenced, represented by the | be represented by | |
| | combination of DNN and | AF-Service-Identifier, | |
| | optionally S-NSSAI, and | instead of | |
| | application identifier or traffic | combination of DNN | |
| | filtering information. | and optionally | |
| | | S-NSSAI. | |
| Potential | Indicates potential locations of | The potential | Conditional |
| Locations of | applications, represented by a | locations of | |
| Applications | list of DNAI(s). | applications can be | |
| | | represented by | |
| | | AF-Service-Identifier. | |
| Target UE | Indicates the UE(s) that the | GPSI can be applied | Mandatory |
| Identifier(s) | request is targeting, i.e. an | to identify the | |
| | individual UE, a group of UE | individual UE, or | |
| | represented by Internal Group | External Group | |
| | Identifier, or any UE | Identifier can be | |
| | accessing the combination of | applied to identify a | |
| | DNN, S-NSSAI and DNAI(s). | group of UE. | |
| Spatial | Indicates that the request | The specified location | Optional |
| Validity | applies only to the traffic of | can be represented by | |
| Condition | UE(s) located in the specified | a list of geographic | |
| | location, represented by areas | zone identifier(s). | |
| | of validity. | | |
| AF transaction | The AF transaction identifier | N/A | Mandatory |
| identifier | refers to the AF request. | | |
| Traffic | Routing profile ID and/or N6 | N/A | Optional |
| Routing | traffic routing information | | |
| requirements | corresponding to each DNAI. | | |
| Application | Indicates whether an | N/A | Optional |
| Relocation | application can be relocated | | |
| Possibility | once a location of the | | |
| | application is selected by the | | |
| | 5GC. | | |
| UE IP address | Indicates UE IP address | N/A | Optional |
| preservation | should be preserved. | | |
| indication | | | |
| Temporal | Time interval(s) or | N/A | Optional |
| Validity | duration(s). | | |
| Condition | | | |
| Information on | Indicates whether the AF | N/A | Optional |
| AF | subscribes to change of UP | | |
| subscription to | path of the PDU Session and | | |
| corresponding | the parameters of this | | |
| SMF events | subscription. | | |

Service information for a set of UEs can be included in one of the current information elements. For example, the service information can be included in the AF request as a kind of targeting UE identifiers. In some other embodiments of the present application, new information element separate from the element of Targeting UE Identifier(s), e.g., Service Information may be added compared with the existing AF request, and the service information for a set of UEs can be combined with the targeting UE identifiers to identify the set of UEs. According to some embodiments of the present application, service information for different UE sets accessing the application with the associated traffic routing information may even be sent to the PCF in a single AF request. In this case, the service information is associated with its corresponding traffic routing information.

The related information included in the AF request may be sent to the PCF via the NEF, stored in the UDR, and then delivered to the PCF, e.g., following the existing application function influence on traffic routing procedure. Data Key for the stored information may include AF Transaction Internal ID, S-NSSAI and DNN and application ID and ACC, wherein ACC is the key for service information being application client category. Persons skilled in the art should well know that the key “ACC” is only used for clear illustration, and other word(s) can be used as the data key to represent the service information. Meanwhile, when the service information is other kind of information, the key can use other wording to represent the service information. For easy management of the targeting UE(s) with the service information for the application(s),a specific internal group ID may be allocated by the UDM corresponding to the targeting UEs with the service information.

An application client or application user in the UE with the service specific information may request the IP address of a server of the application and logs in in step 303. The user-plane communication takes place between the application client in the UE and the application server via the C-UPF. The application layer can decide that the service specific information of the application client in the UE, i.e., service specific information of the application client based on configuration or application subscription information. The service specific information of the application client is associated with the identifier of the UE or the address of the UE while the application is accessing via the UE. In the embodiments illustrated in FIG. 3, the service specific information of the UE is associated with the address of the UE.

The AF gets the service specific information of the UE accessing the application from the application side and provides it to the PCF in step 304. The ID of the application and the address of the UE can also be provided to the PCF together with the service specific information. For example, the service specific information can be delivered to the PCF directly or indirectly by the procedure of setting up an AF session with required QoS defined in 3GPP TS 23.502 clause 4.15.6.6 or by the procedure of service specific parameter provisioning defined in 3GPP TS 23.502 clause 4.15.6.7 or by a procedure of application function influence on traffic routing as defined in 3GPP TS 23.502 clause 4.3.6.4.

If the service specific information for the UE is received and there is no traffic routing information for the specific application with the related service information for the application ID and a set of UEs in the PCF as described, it may trigger the PCF to retrieve the traffic routing information with the related service information for a set of UEs for the application.

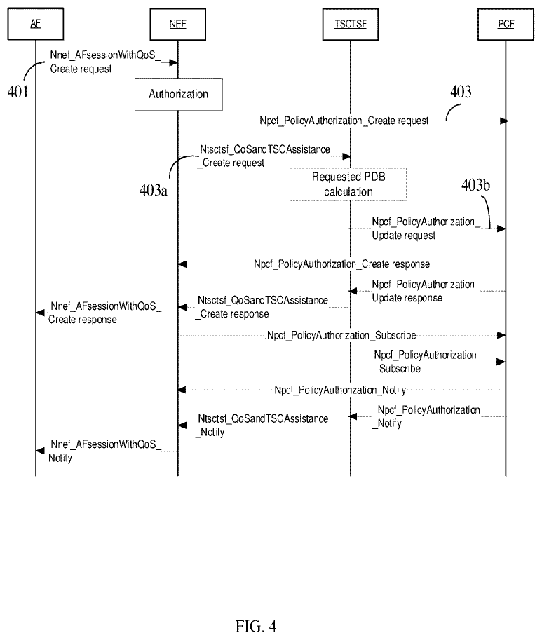

FIG. 4 illustrates a procedure of setting up an AF session with required QoS according to some embodiments of the present application.

Referring to FIG. 4, the information from the AF is delivered to the PCF via the NEF. The service specific information of the UE is associated with the UE address, and is transmitted to the NEF with External Application Identifier included in the AF request by invoking Nnef_AFsession WithQoS_Create service in step 401.

As defined in 3GPP TS 23.502, in steps 403, 403a and 403b, the NEF interacts with the PCF by triggering a Npcf_PolicyAuthorization_Create request and provides the UE address, AF Identifier, and External Application Identifier. The service specific information of the UE is also transmitted to the PCF by the NEF via steps 403, 403a and 403b.

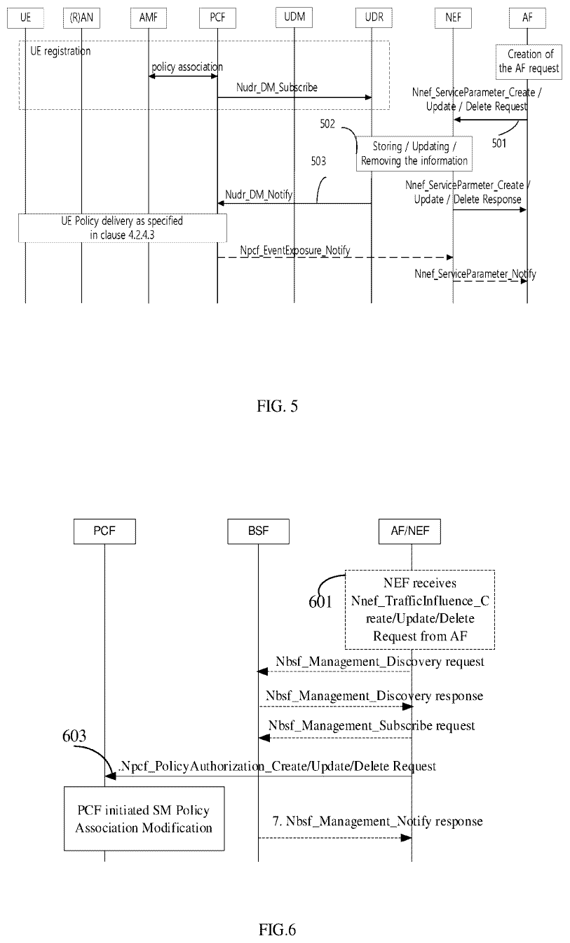

FIG. 5 illustrates a procedure of service specific parameter provisioning according to some embodiments of the present application.

Referring to FIG. 5, the service specific information of the UE and the application identifier (application ID) are included in the AF request by invoking Nnef_ServiceParameter_Create in step 501. The service specific information is associated with the UE address, which is identified by GPSI or UE IP address or UE IP prefix etc.

In step 502, the NEF stores the information included in the AF request in the UDR as the “Application Data,” wherein Data Subset is set as “Service specific information,” together with the assigned Transaction Reference ID. Compared with to the existing procedure, the service specific information is also stored in the UDR.

Then, in step 503, the PCF(s) receive(s) a Nudr_DM_Notify notification of data change from the UDR including the service specific information.

FIG. 6 illustrates a procedure of application function influence on traffic routing according to some embodiments of the present application.

Referring to FIG. 6, in step 601, the service specific information of the UE and the application identifier (application ID) are included in the AF request, e.g., Nnef_TrafficInfluence_Create Request, and the NEF receives Nnef_TrafficInfluence_Create Request from the AF. The service specific information is associated with the UE address, which is identified by GPSI or UE IP address or UE IP prefix etc.

Then, in step 603, the NEF interacts with the PCF by triggering a Npcf_PolicyAuthorization_Create request and provides the UE address, AF Identifier, and External Application Identifier. The service specific information of the UE is also transmitted to the PCF by the NEF in step 603.

Besides the existing procedure, new procedure(s) among the AF, the NEF, UDR, and PCF can be defined for delivering the service specific information from the AF to the PCF, which may be similar to the procedure of setting up an AF session with required QoS or the procedure of service specific parameter provisioning or the procedure of application function influence on traffic routing as illustrated above. Since the AF can interact with the PCF directly or via the NEF. The path for delivering the information from the AF to the PCF in the new procedure(s) can be: from the AF to the PCF, or from the AF to the NEF and then to the PCF, or from the AF to the NEF, then to the UDR and then to the PCF.

Returning to FIG. 3, the PCF will match the service specific information of the UE received in step 304 with the service information for a set of UEs received in step 301. When the service specific information of the UE matches with the service information for a set of UEs, the PCF makes a decision to modify the SM policy for the application within the PDU session in step 305. The PCF will generate a traffic routing policy based on the service information matched with the service specific information of the UE and the traffic routing information associated with the service information. Then, the PCF will transmit the traffic routing policy to the SMF. Accordingly, the SMF will perform SM policy control in step 306.

The UE may move and enter the service area of the edge DN where the application is deployed in step 307.

The SMF will establish UL CL and L-UPF for local access of the UE based on the received traffic routing policy. For example, in steps 308, 309a, 309b and 310, the SMF may decide to establish a new PDU session anchor e.g., due to UE mobility as described in step 307, based on the received traffic routing policy. When the UL CL is inserted, the UE IP address is not changed, the service specific information of the UE received in step 304 which is associated with the UE IP address or UE IP prefix is still valid, and the traffic routing policy for the application client accessing the application via the UE is still valid.

Then, in step 311, user-plane communication takes place between the application client in UE and EAS via the local UPF.

When the application client with the service specific information logs out of the application or the IP flows of the application are terminated in step 312, the AF may decide to delete the service specific information of the application client in step 313. The deletion procedure is similar to the procedure described in step 304, and the difference there between is the procedure in step 313 is to request the PCF to delete the related information. For example, in the deletion procedure, the service specific information of the UE and the application identifier are included in the AF request by invoking Nnef_ServiceParameter_Delete in step 501, rather than Nnef_ServiceParameter_Create.

The service information of the application for a set of UEs may change (or update). Similarly, the service specific information of the UE may also change (or update). The update procedure of the service specific information of the UE is also similar to the procedure described in step 304, and the difference therebetween is the procedure in step 313 is to request the PCF to update the related information. For example, in the service specific information update procedure, the service specific information of the UE and the application identifier are included in the AF request by invoking Nnef_ServiceParameter_Update step 501, in rather than Nnef_ServiceParameter_Create. In response to any one of the above, the PCF will make a decision to modify the SM policy for the traffic within the PDU session, and the traffic routing policy associated with the application client will be updated in the SMF in step 314.

If an application client, which has no service specific information associated with the application, requests the IP address of the application server and logs in in the PDU session of the UE, the related traffic routing policy will not be applied to the UE for the accessing traffic, and the user-plane communication will take place between the application client in the UE and the application server via the C-UPF in step 316. When the SMF performs traffic routing control for the application client in step 317, if the application client without service specific information does not belong to any set of UEs associated with any traffic routing information, no traffic routing policy will be sent to the SMF. Thus, no traffic routing policy will be applied to the application for this UE. Similarly, in step 318, no UP relocation is triggered if there is no related traffic routing policy, the user-plane communication keeps taking place between the application client in the UE and the application server via the C-UPF, the AF cannot get the service specific information of the UE from the application side, and no traffic routing to the local EAS is performed.

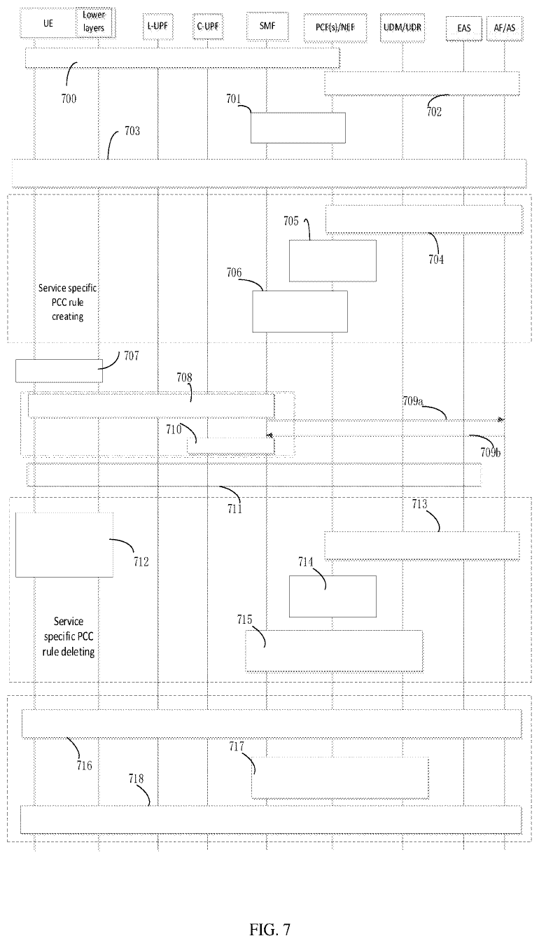

FIG. 7 illustrates an exemplary procedure of traffic routing controlling based on the service information for PDU session using multi-homing according to some embodiments of the present application. It is supposed that both the service information for a set of UEs and the service specific information of a specific UE is configured in the application side in the illustrated embodiments shown in FIG. 7.

According to some embodiments of the present application, for a PDU session using multi-homing, the local PSA is L-UPF selected based on traffic routing information, the central PSA is C-UPF, and a new UE IP address is allocated during local offloading of the PDU session. The PCF will decide to send the PCC rule with the traffic routing policy generated and delivered based on service information and traffic routing policy matched or associated with the service information.

Referring to FIG. 7, a UE may initiate the PDU session establishment procedure in step 700 to request accessing the application.

The SMF will retrieve the SM policy using a SM policy association establishment procedure during the PDU session establishment procedure in step 701. The traffic routing policy for the application may also be retrieved in this step similar to step 301. Since no service information has been matched yet, there is no traffic routing policy for the specific application sent to the SMF for the PDU session. Accordingly, the SMF cannot retrieve the related traffic routing policy.

Similar to step 302, in step 702, the AF will transmit the service information, e.g., an allowance indication of the application to the PCF with the ID of the application, e.g., by an AF request in an application function influence on traffic routing procedure defined in 3GPP TS 23.501 and TS 23.502. The traffic routing information associated with the service information for the set of UEs can also be included in the AF request.

The related information included in the AF request may be sent to the PCF via the NEF, stored in the UDR, and then delivered to the PCF, e.g., following the existing application function influence on traffic routing procedure. Data Key for the stored information may include AF Transaction Internal ID, S-NSSAI and DNN and application ID and Allowance Indication, wherein “Allowance Indication” is the key for service information being allowance indication. Persons skilled in the art should well know that the key “Allowance Indication” is only used for clear illustration, and other word(s) can be used as the data key to represent the service information. When the service information is other kind of information, the key(s) can use other wording to represent the corresponding service information.

In step 703, an application client in the UE with service specific information may request the IP address of a server of the application and logs in. The user-plane communication may take place between the application client in the UE and the application server via the C-UPF. The application layer can decide that the service specific information of the application client in the UE, i.e., service specific information of the UE based on configuration or application subscription information. The service specific information of the UE is associated with the identifier of the UE or the address of the UE. In the embodiments illustrated in FIG. 7, the service specific information of the UE is associated with the identifier of the UE (e.g., GPSI in the AF or SUPI mapped from GPSI).

The AF gets the service specific information of the UE accessing the application from the application side and provides it to the PCF with the ID of the application in step 704 similar to step 304. Different from step 304, UE ID instead of UE address is provided to the PCF, which can be GPSI gotten by the AF invoking the Nnef_UEId_Get.Besides. In addition, the service specific information of the UE should be consistent with that received in step 701. For example, if the service information for a set of UEs of the application is an allowance indication, the service specific information is also the information indicating whether the application client is allowed to access the application using edge computing, and optionally with specified information, e.g., an allowance indication for the application with the specified performance level. The specified information can be implemented reusing the existing information e.g. the user plane latency requirement defined in in 3GPP TS 23.501 clause 5.6.7 or adding new information.

In step 705, the PCF will match the service specific information of the UE received in step 704 matched with the service information for a set of UEs received in step 701. When the service specific information of the UE matches with the service information for a set of UEs, the PCF makes a decision to modify the SM policy for the application within the PDU session. The PCF will generate a traffic routing policy based on the service information matched with the service specific information of the UE and the traffic routing information associated with the service information. Then, the PCF will transmit the traffic routing policy to the SMF. Accordingly, the SMF will perform SM policy control in step 706.

The UE may move and enter the service area of the edge DN where the application is deployed in step 707.

The SMF will establish BP and L-UPF for local access of the UE based on the received traffic routing policy. For example, in steps 708, 709a, 709b and 710, the SMF may decide to establish a new PDU session anchor e.g., due to UE mobility as described in step 707, based on the received traffic routing policy. When BP is inserted, the new UE IP address is allocated, and the AF can get the notification for user-plane path change. Thus, the AF can decide that: the new UE IP is also associated with the same application client accessing the application, the service specific information received in step 704 which is associated with the UE ID is still valid, and the related traffic routing policy for the application accessing via the UE is still valid. Otherwise, if the AF decide that: the new UE IP is not associated with the same application client accessing the application, the AF can decide to delete the service specific information previously received in step 704 for the PDU session and create a new one to associate it with the UE address or UE ID.

Then, in step 711, user-plane communication takes place between the application client in UE and EAS via the local UPF.

Similar to steps 312 and 313, when the applicant client with the service specific information logs out of the application or the IP flows of the application are terminated in step 312, the AF may decide to delete the service specific information of the application client in step 313. The deletion procedure is similar to the procedure described in step 704, and the difference therebetween is the procedure in step 713 is to request the PCF to delete the related information.

Similar to steps 314 and 315, in response to change or update of at least one of: service information of the application for a set of UEs or the service specific information of the UE, the PCF will make a decision to modify the SM policy for the application client within the PDU session, and the traffic routing policy associated with the application client will be updated or deleted in the SMF in steps 714 and 715.

If the application client with the service specific information requests the IP address of the application server in another UE different from the previous one, the user-plane communication will take place between the application client in the new UE and application server via the C-UPF in step 716. The SMF will perform traffic routing control for the application client in the new UE in step 717. Since the application client is allowed to access the application using edge computing, steps as the same as 704 to 715 will be performed in step 718, so that the traffic routing policy for the same application client is applied to the application no matter which UE is used to access the application.

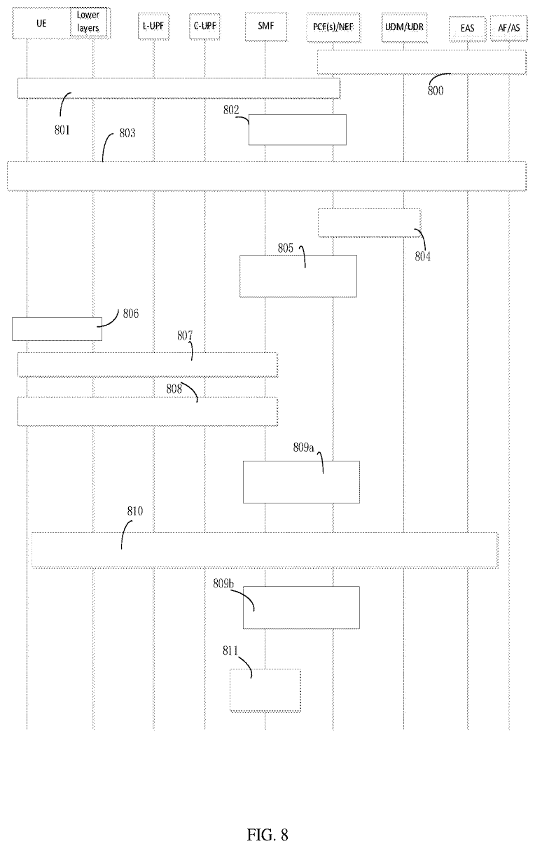

FIG. 8 illustrates an exemplary procedure of traffic routing controlling based on the service information for PDU session using SSC mode 2 according to some embodiments of the present application. In the illustrated embodiments shown in FIG. 8, it is supposed that the service information for a set of UEs is configured in the application side, while the service specific information of a specific UE, e.g., an allowance indication with a performance level for an application is configured or provisioned in the mobile network side.

According to some embodiments of the present application, for a PDU session using SSC mode 2, the local PSA is L-UPF selected based on traffic routing information, the central PSA is C-UPF, and a new PDU session is established during local offloading of the PDU session. The PCF decides to send the PCC rule with the traffic routing policy generated and delivered based on service information and traffic routing information matched or associated with the service information.

Referring to FIG. 8, similar to step 302 and step 702, in step 800, the AF will transmit the service information, e.g., an allowance indication of the application to the PCF with the ID of the application, e.g., by an AF request in an application function influence on traffic routing procedure defined in 3GPP TS 23.501 and TS 23.502. The traffic routing information associated with the service information for the set of UEs can also be included in the AF request. For example, the related information included in the AF request may be sent to the PCF via the NEF, stored in the UDR, and then delivered to the PCF, e.g., following the existing application function influence on traffic routing procedure. Data Key for the stored information may include AF Transaction Internal ID, S-NSSAI and DNN and application ID and Allowance Indication, wherein “Allowance Indication” is the key for service information being allowance indication.

Alternatively, the traffic routing information associated with the service information for the set of UEs can also be configured in the mobile network side.

A UE may initiate the PDU session establishment procedure in step 801 to request accessing the application. The SMF will retrieve the SM policy using a SM policy association establishment procedure during the PDU session establishment procedure in step 802. However, similar to step 301 and step 701, no traffic routing policy for the PDU session is retrieved in this step.

An application client in the UE with service specific information may request the IP address of a server of the application and logs in in step 803. The user-plane communication takes place between the application client in the UE and the application server via the C-UPF.

The service specific information is configured in the mobile network side for the UE accessing the application. The configured service specific information can be stored in the UDR and sent to the PCF or configured to the PCF directly. Exemplary service specific information may include: allowed edge service information, including an identifier of at least one application which can be accessed using edge computing by the UE; and service information of each application for a set of UEs to which the UE belongs in the allowed edge service information. According to some embodiments of the present application, the configured service specific information may further include the subscriber categories of the UE included in PDU session policy control subscription information defined in 3GPP TS 23.503.

The traffic in step 803 is detected and triggers the SM policy modification in step 805. The PCF will match the service specific information of the UE retrieved in step 804 with the service information for a set of UEs received in step 800. When the service specific information of the UE matches with the service information for a set of UEs, the PCF will make a decision to modify the SM policy for the application within the PDU session. The PCF will generate a traffic routing policy based on the service information matched with the service specific information of the UE and the traffic routing information associated with the service information. Then, the PCF will transmit the traffic routing policy to the SMF. Accordingly, the SMF will perform SM policy control.

The UE may move and enter the service area of the edge DN where the application is deployed in step 806. The PDU session with the C-UPF is released in step 807, while the PDU session with L-UPF is established in step 808.

In step 809a and step 809b, the SMF will retrieve the SM policy using a SM policy association establishment procedure. The traffic routing policy for the application may be retrieved in these steps if the service specific information for the UE has already been configured similar as described in step 805 based on the traffic data detection for the application.

In step 810, user-plane communication will take place between the application client in UE and EAS via the local UPF and the new UE IP address. The SMF will make a routing decision for traffic of PDU session and control the traffic routing in step 811 based on the received traffic routing policy.

Other potential procedures, e.g., traffic routing policy deletion or updating etc., are similar to the above illustrated embodiments, and thus will not repeat again.

In some embodiments of the present application, traffic routing control can also be applied for a set of UEs accessing the same application instance of an application. The set of UEs can be associated together under certain conditions. For example, during a match of an online multiplayer game, the players within this match can have the same traffic routing control, e.g., with the same performance. The service information for the set of UEs can be the same application instance that the set of UEs are accessing, e.g., the identifier of one match of the game application that the set of UEs are accessing.

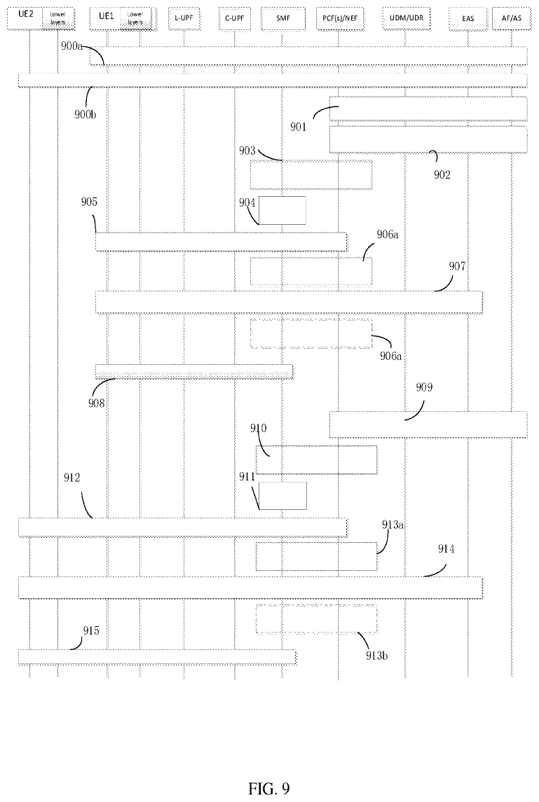

FIG. 9 illustrates an exemplary procedure of traffic routing controlling based on application instance according to some embodiments of the present application.

Referring to FIG. 9, SSC mode 3 with multiple PDU sessions is used for local offload traffic. The target PSA is L-UPF selected based on the traffic routing information the central PSA is C-UPF, and a new PDU session is established during the local offloading of the PDU session. The PCF decides to send the PCC rule with the traffic routing policy generated and delivered based on the service information, e.g., application instance and the traffic routing information matched/associated with the service information. In addition, it is supposed that both the service information for a set of UEs and the service specific information of a specific UE is configured in the application side.

Multiple UEs, e.g., UE1 and UE2 playing the same match of a game, are illustrated in FIG. 9. In step 900a, UE1 initiates the PDU session establishment procedure with C-UPF and communicates with the application servicer for the application, and in step 900b, UE2 initiates the PDU session establishment procedure with C-UPF and communicates with the application servicer for the application.

Similar to step 302 and step 702, in step 901, the AF will transmit the service information, e.g., an application identifier associated with the application instance to the PCF with the ID of the application, e.g., by an AF request in an application function influence on traffic routing procedure defined in 3GPP TS 23.501 and TS 23.502. The players of the match will be within the same set of UEs with identified by the same application instance identifier. The traffic routing information associated with the service information for the set of UEs can also be included in the AF request. For example, the related information included in the AF request may be sent to the PCF via the NEF, stored in the UDR, and then delivered to the PCF, e.g., following the existing application function influence on traffic routing procedure. Data Key for the stored information may include AF Transaction Internal ID, S-NSSAI and DNN and application ID and Application Instance Identifier, wherein “Application Instance Identifier” is the key for service information being application instance identifier.

Similar to step 304, step 704 and step 804 illustrated above, the service specific information of UE1, which is consistent with the application instance identifier identifying the application instance that UE1 is accessing, can be sent to the PCF by the AF directly or indirectly or can be configured to the PCF. Accordingly, the service specific information of UE1 is received by the PCF from the AF or is retrieved by the PCF in step 902. Similarly, for UE2, the service specific information of UE2 is also received by the PCF from the AF or is retrieved by the PCF in step 909.

In step 903, SMF will retrieve the SM policy. When the service specific information of the UE matches with the application instance identifier, the traffic routing information associated with the application instance identifier will be retrieved by the SMF.

In step 904, the SMF will perform traffic routing control according to the traffic routing policy accordingly. PDU session establishment with L-UPF is also performed based on the traffic routing policy received in step 901 if available in step 905

The SMF will retrieve the SM policy in steps 906a using a SM policy association establishment procedure during the PDU session establishment procedure in step 907 or in 906b using a SM policy association modification procedure during the lifetime of the PDU session. The traffic routing policy for the application may be retrieved if the service specific information is already configured and is matched with the service information, e.g., the application instance received in step 901. After edge relocation, user-plane communication between UE1 and EAS via the L-UPF. The traffic routing policy for the application may be received in the SMF based on the traffic data detection for the application in step 906b. Then, in step 908, the PDU session with C-UPF for UE1 will be released.

As the same as the operations on UE1, i.e., steps 902-908, the service specific information of UE, which identifies UE2 with the same application instance identifier and belongs to the same set of UE2 as UE1 will be sent to the PCF or configured to the PCF, and the traffic routing control will be performed for UE2 in steps 909-915. Accordingly, UE1 and UE2 will be controlled using the same traffic routing policy.

Persons skilled in art should well know that in some scenarios, more than one application may use the same traffic routing control policy. The service information for the set of UEs and the associated traffic routing information can be applied for the more than one application. Thus, in all embodiments of the present application, the more than one application will be associated with the service information and traffic routing information. Each application can be identified by the application identifier or traffic filtering information, and thus the application identifier illustrated in the embodiments of the application can be replaced by traffic filtering information.

Besides methods of reporting buffer status, some embodiments of the present application also provide an apparatus of traffic routing control, e.g., a NF of policy control.

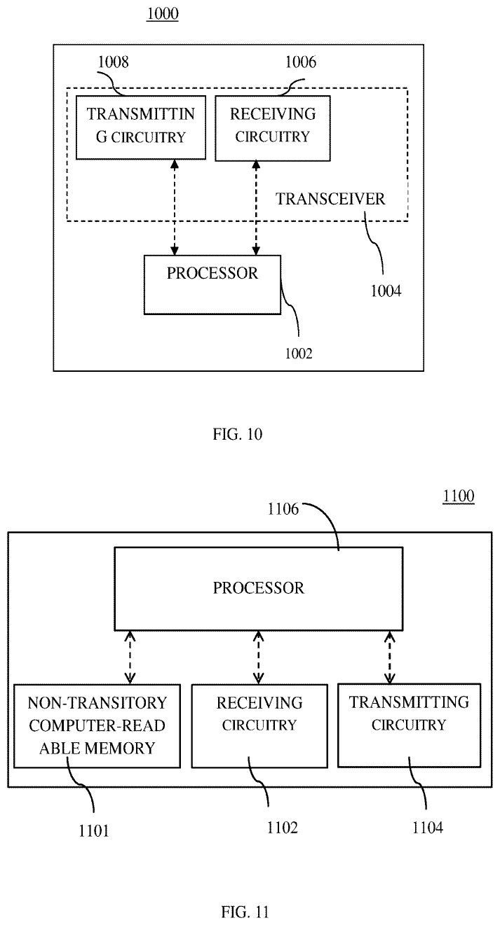

For example, FIG. 10 is a block diagram of an apparatus of traffic routing control according to some embodiments of the present application.

Referring to FIG. 10, the apparatus 1000, for example a UE may include at least one processor 1002 and at least one transceiver 1004 coupled to the at least one processor 1002. The transceiver 1004 may include at least one separate receiving circuitry 1006 and transmitting circuitry 1008, or at least one integrated receiving circuitry 1006 and transmitting circuitry 1008. The at least one processor 1002 may be a CPU, a DSP, a microprocessor etc.

According to some embodiments of the present application, when the apparatus 1000 is a PCF, the processor is configured to: receive or retrieve service specific information of a UE requesting to access an application; match the service specific information of the UE with service information for a set of UEs, wherein the service information is associated with traffic routing information targeting the set of UEs; and transmit a traffic routing policy based on the service information and the traffic routing information to influence a receiving NF of session management for routing decisions for traffic.

FIG. 11 illustrates a block diagram of an apparatus of traffic routing control 1100 according to some other embodiments of the present application.

As shown in FIG. 11, the apparatus 1100 may include at least one non-transitory computer-readable medium 1101, at least one receiving circuitry 1102, at least one transmitting circuitry 1104, and at least one processor 1106 coupled to the non-transitory computer-readable medium 1101, the receiving circuitry 1102 and the transmitting circuitry 1104. The at least one processor 1106 may be a CPU, a DSP, a microprocessor etc. The apparatus 1100 may be a PCF configured to perform a method illustrated in the above or the like.

Although in this figure, elements such as the at least one processor 1106, transmitting circuitry 1104, and receiving circuitry 1102 are described in the singular, the plural is contemplated unless a limitation to the singular is explicitly stated. In some embodiments of the present application, the receiving circuitry 1102 and the transmitting circuitry 1104 can be combined into a single device, such as a transceiver. In certain embodiments of the present application, the apparatus 1100 may further include an input device, a memory, and/or other components.

In some embodiments of the present application, the non-transitory computer-readable medium 1101 may have stored thereon computer-executable instructions to cause a processor to implement the method with respect to the UE as described above. For example, the computer-executable instructions, when executed, cause the processor 1106 interacting with receiving circuitry 1102 and transmitting circuitry 1104, so as to perform the steps with respect to the PCF as depicted above.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device capable of implementing the flowcharts shown in the figures may be used to implement the processor functions of this application. For example, an embodiment of the present application provides an apparatus, including a processor and a memory. Computer programmable instructions for implementing a method are stored in the memory, and the processor is configured to perform the computer programmable instructions to implement the method. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method as stated above or other method according to an embodiment of the present application.

In addition, in this disclosure, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “having,” and the like, as used herein, are defined as “including.”

What is claimed is:

1. An apparatus for wireless communication, comprising:
at least one memory; and
at least one processor coupled with the at least one memory and configured to cause the apparatus to:
receive or retrieve service specific information of a user equipment (UE) requesting to access an application;
match the service specific information of the UE with service information for a set of UEs, wherein the service information is associated with traffic routing information targeting the set of UEs; and
transmit a traffic routing policy based on the service information and the traffic routing information.

2. The apparatus of claim 1, wherein the service information comprises one or more of:
an application client category associated with a service level of the application;
an allowance indication for the application; or
an application identifier associated with an application instance.

3. The apparatus of claim 1, wherein the service information for the set of UEs is received as part of application function data for a traffic routing procedure.

4. The apparatus of claim 3, wherein the service information comprises targeting UE identifiers in an application function request or separate information combinable with the targeting UE identifiers to identify the set of UEs.

5. The apparatus of claim 3, wherein the service information is configured in mobile network side, and is directly stored at the apparatus or stored in a network function of unified data repository.

6. The apparatus of claim 1, wherein the service specific information of the UE is received via one or more of a procedure of setting up an application function (AF) session with required quality of service (QOS), a procedure of service specific parameter provisioning, or a procedure of application function for traffic routing.

7. The apparatus of claim 1, wherein the service specific information of the UE is configured in mobile network side, and is directly stored at the apparatus or stored in a network function of unified data repository.

8. The apparatus of claim 7, wherein the service specific information of the UE is configured to include one or more of:
allowed edge service information, including an identifier of at least one application accessible using edge computing by the UE; or
service information of each application for a set of UEs to which the UE belongs in the allowed edge service information.

9. A method performed by an apparatus, the method comprising:
receiving or retrieving service specific information of a user equipment (UE) requesting to access an application;
matching the service specific information of the UE with service information for a set of UEs, wherein the service information is associated with traffic routing information targeting the set of UEs; and
transmitting a traffic routing policy based on the service information and the traffic routing information.

10. The method of claim 9, wherein the service information comprises one or more of:
an application client category associated with a service level of the application;
an allowance indication for the application; or
an application identifier associated with an application instance.

11. The method of claim 9, further comprising receiving the service information for the set of UEs as part of application function data for a traffic routing procedure.

12. The method of claim 11, wherein the service information comprises targeting UE identifiers in an application function request or separate information combinable with the targeting UE identifiers to identify the set of UEs.

13. The method of claim 9, further comprising receiving the service specific information of the UE via one or more of a procedure of setting up an application function (AF) session with required quality of service (QOS), a procedure of service specific parameter provisioning, or a procedure of application function for traffic routing.

14. The method of claim 9, wherein the service specific information of the UE is configured in mobile network side, and is directly stored at the apparatus or stored in a network function of unified data repository.

15. The method of claim 14, wherein the service specific information of the UE is configured to include one or more of:
allowed edge service information, including an identifier of at least one application accessible using edge computing by the UE; or
service information of each application for a set of UEs to which the UE belongs in the allowed edge service information.

16. The apparatus of claim 1, wherein the apparatus implements a network function for policy control.

17. The method of claim 9, wherein the apparatus implements a network function for policy control.

18. An apparatus for wireless communication, comprising:
at least one memory; and
at least one processor coupled with the at least one memory and configured to cause the apparatus to:
receive first information comprising traffic routing information for an application, the first information comprising service specific information of a user equipment (UE) requesting to access to the application; and
transmit second information comprising one or more of an application category for the application or an indication of whether an application client associated with the UE is permitted access to the application.

19. The apparatus of claim 18, wherein the apparatus implements an application function of a wireless network.

20. A method performed by an apparatus, the method comprising:
receiving first information comprising traffic routing information for an application, the first information comprising service specific information of a user equipment (UE) requesting to access to the application; and
transmitting second information comprising one or more of an application category for the application or an indication of whether an application client associated with the UE is permitted access to the application.
